(19) United States
(12) Patent Application Publication
(10) Pub. No.: US 2002/0093929 A1
(43) Pub. Date: Jul. 18, 2002

(54) System and method for sharing bandwidth between co-located 802.11a/e and HIPERLAN/2 systems

(75) Inventors: Stefan Y. Mangold, Aachen (DE); Sunghyun Choi, Montvale, NJ (US); Wolfgang Budde, Hander Weg (DE)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/023,120

(22) Filed: Dec. 17, 2001

Related U.S. Application Data
(60) Provisional application No. 60/262,590, filed on Jan. 18, 2001.
(60) Provisional application No. 60/303,965, filed on Jul. 9, 2001.

(51) Int. Cl. H04J 3/00

(52) U.S. Cl. 370/336; 370/468; 370/455

(57) ABSTRACT

A system and method for allocating a time slot to support data transmission between the co-located 802.11a/e and HIPERLAN/2 systems in a wireless local area network (WLAN) are provided. To comply with the H2 standard requirement of periodic transmission of the frame at every 2 msec, the access point (AP) performs the QoS CF-Poll function to allow the transmission of the H2 MAC frames to occur at n * 2 msec interval in the CCHC superframe, where the value of n depends on the HIPERLAN/2 MAC frame schedule of the AP. In particular, the AP polls itself to make other stations silent using the QoS CF-Poll function, then allocates a predetermined time period at each station to initiate H2 frame exchanges.

### CROSS REFERENCE TO RELATED APPLICATION

This application claims the benefit of U.S. Provisional Applications Serial No. 60/262,590, filed Jan. 18, 2001, and U.S. Provisional Applications Serial No. 60/303,965, filed Jul. 9, 2001, the teachings of which are incorporated herein by reference.

### BACKGROUND OF THE INVENTION

1. Field of the Invention

The present invention relates to a mechanism to share the bandwidth between two different systems in a time-sharing manner. More particularly, the present invention relates to a medium access protocol (MAC) arrangement that employs the 802.11e Hybrid Coordination Function (HCF) to share the bandwidth between 802.11a/e and HIPERLAN/2 (H/2) systems.

2. Description of the Invention

The wireless local area network (WLAN) is a fast-growing market designed to provide the flexibility of wireless access into the office, home, production, or public environment. This unprecedented growth is fueled by the popularity of portable end-user devices and advances in wireless data communications.

Basically, there are two variants of WLAN: infrastructure-based and ad hoc. In the infrastructure-based wireless network, communication typically takes place only between the wireless nodes and the access point (AP), not directly between the wireless nodes. The wireless nodes, called stations (STA), can exchange data via the AP. The set of stations and the AP, which are within the same radio coverage, is known as a basic service set (BSS). The main functions of the AP are to support roaming (i.e., changing access points), synchronize within a BSS, support power management, and control the medium access to support time-bounded service within a BSS. Several BSSs (or APs) are interconnected via a system called the distribution system (DS) to form a single network to extend the wireless coverage area. In the ad hoc network, each node can communicate with another node if they are within each other's radio range or if other nodes can forward the message.

In contrast to the wireline technologies, the WLAN is typically restricted in its diameter to buildings, a campus, a single room, etc., and has much a lower bandwidth due to limitations in radio transmission (i.e., typically 1-11 Mbit/s). Thus, it is highly desirable to utilize the wireless link bandwidth efficiently in the WLAN. In wirelessbased networks, collision detection can be performed with relative ease. However, it is more difficult to detect collision in a wireless-based network, which uses a single channel. Thus, the WLAN typically employs a collision avoidance scheme instead of collision detection.

The WLANs can be configured based on a medium access control (MAC) protocol using a CSMA/CA (carrier sense multiple access with collision avoidance) as described in the IEEE 802.11 standard. The IEEE 802.11 standard is defined in the International Standard ISO/IEC 8802-11, “Information Technology—Telecommunications and information exchange area networks,” 1999 Edition, which is hereby incorporated by reference in its entirety. IEEE 802.11a is an extension to the IEEE 802.11 physical layer (PHY) to support 6-54 Mbit/s transmission rates at 5 GHz frequency bands. In Europe, the HIPERLAN 2 (H2) standard, which is set forth by the European Telecommunications Standards Institute (ETSI), specifies the MAC and physical characteristics for the WLAN to support physical layer units at 5 GHz frequency bands.

When both the IEEE 802.11 and the H2 compliant systems coexist in the same frequency channel, they work as co-channel interferers to each other by degrading the network performance severely. As such, a centralized controller is needed to render the time-sharing of the bandwidth between the systems. Accordingly, the present invention provides a mechanism to control the signal transmission over the co-located 802.11a/e (where 802.11e is an extension of the MAC to support QoS) and H2 networks by sharing the bandwidth in a time-sharing manner, without sacrificing the QoS support of both systems and wasting much bandwidth during the interworking.

### SUMMARY OF THE INVENTION

The present invention is directed to a system and method of allocating a time slot to support data transmission between the co-located 802.11a/e and H2 systems in a wireless local area network (WLAN).

According to an aspect of the invention, the method of sharing the bandwidth over a wireless channel between a plurality of first stations and a plurality of second stations in a wireless local area network (WLAN) having an access point (AP) includes the steps of: periodically transmitting, by the AP, a control frame comprising data indicative of a predetermined time interval during which each of the first stations can occupy the wireless channel for the data transmissions onto the wireless channel; determining, by the AP, whether the predetermined time interval specified in the control frame is longer than an interval of time following receipt of a last frame from one of the first stations and before a scheduled start of a set of next frames from the second stations; if so, waiting, by the AP, for point interframe spacing interval (PIFS) after which the next frames from the second stations are permitted to transmit to the AP over the wireless channel; inhibiting transmission from the plurality of first stations to the AP; and, permitting the plurality of second stations to transmit a data packet to the AP over the wireless channel, wherein the data packet including a shorter duration than the predetermined time period specified in the control signal. If the predetermined time interval specified in the control frame is less than the interval of time before the scheduled start of the next frame, transmitting, by the AP, a data packet to the plurality of first and second stations over the wireless channel, the data packet including a shorter duration than the predetermined time period specified in the control signal, or permitting the plurality of first stations to transmit a data packet to the AP over the wireless channel, the data packet including a shorter duration than the predetermined time period specified in the control signal. The method further include the steps of: determining whether the wireless channel between the AP and the plurality of first and second stations is available; if so, inhibiting transmission from the plurality of the first stations to the AP; transmitting, from the AP to the plurality of first stations, a high priority signal indicative of a duration that the plurality of second stations is allowed to occupy the wireless channel; and, permitting the plurality of second stations to transmit a data packet to the AP over the wireless channel, the data packet including a shorter duration than the predetermined time period specified in the control signal. The plurality of first stations can transmit data frames without permission from the AP and the plurality of second stations can transmit data frames when permitted by the AP.

According to another aspect of the invention, the method of sharing the bandwidth over a wireless channel between a plurality of first stations and a plurality of second stations in a wireless local area network (WLAN) having an access point (AP) includes the steps of: transmitting a control frame having a contention free period (CFP) mode and a contention period (CP) mode, the control frame including data indicative of a predetermined time interval that each of the first stations has to complete data transmission onto the wireless channel; determining whether the wireless channel between the AP and the plurality of first and second stations is available; if the wireless channel is available during the CP mode, polling at the AP to inhibit transmission of the plurality of first stations over the wireless channel; and, permitting the plurality of second stations to transmit a data packet to the AP over the wireless channel, the data packet including a shorter duration than the predetermined time period specified in the control signal. The step of permitting the plurality of second stations to transmit a data packet to the AP over the wireless channel further comprises the steps of: determining, by the AP, whether the predetermined time interval specified in the control frame is longer than an interval of time following receipt of a last frame from one of the first stations and before a scheduled start of a set of next frames from at least one of the second stations; if so, determining a range of time [t₁, t₂] to control the wireless channel by the AP; and, controlling the wireless channel within the time range to permit the plurality of second stations to transmit a data packet, wherein the range of time is determined according to the following equation: [t₁, t₂]=[−1*(TXOP_Limit+ QoS CF-Poll frame duration+SIFS),−1*QoS CF-Poll frame duration+SIFS), wherein TXOP_Limit represents the predetermined time period that the plurality of first stations can transmit data frames after the wireless channel is determined to be available, QoS CF-Poll frame duration represents the duration of a QoS CF-Poll frame used to instruct the AP to inhibit transmission from the plurality of first stations, and SIFS represents the duration of a Short Interframe Space interval. If the wireless channel is unavailable, permitting the plurality of second stations to transmit a data packet to the AP over the wireless channel immediately when the wireless channel becomes available. If the predetermined time interval specified in the control frame is less than the interval of time before the scheduled start of the next frame, transmitting, by the AP, a data packet to the plurality of first and second stations over the wireless channel, the data packet including a shorter duration than the predetermined time period specified in the control signal, or permitting the plurality of first stations to transmit a data packet to the AP over the wireless channel, the data packet including a shorter duration than the predetermined time period specified in the control signal. If the wireless channel is available during the CFP mode, the method further comprises the steps of: transmitting, from the AP to the plurality of first and second stations, a high priority signal indicative of a duration that the plurality of first and second stations is allowed to occupy the wireless channel; and, permitting the plurality of second stations to transmit a data packet to the AP over the wireless channel, the data packet including a shorter duration than the predetermined time period specified in the control signal.

According to a further aspect of the invention, a local area network system for receiving and transmitting data over a wireless channel between a plurality of first stations and a plurality of second stations in a wireless local area network (WLAN) having an access point (AP), comprising: a receiver means for receiving data on the wireless channel; a transmitter means for transmitting data on the wireless channel; a CCHC circuit configured to allocate a predetermined time interval for each of the first and second stations to initiate data transmission onto the wireless channel; and, a signal processing circuit coupled to the CCHC to transmit and receive signals to and from the plurality of first and second stations, the signal processing circuit processes signals received therein to permit the plurality of second stations to transmit a data packet to the AP over the wireless channel, the data packet including a shorter duration than the predetermined time period specified in the control signal. The CCHC further operates to inhibit transmission from the plurality of first and the second stations when permitting the plurality of second stations to transmit a data packet. The CCHC further operates to transmit a data packet to the plurality of first and second stations over the wireless channel if the predetermined time interval is less than the time left before a scheduled start of a next frame by the plurality of second stations. The CCHC further operates to permit transmission of the plurality of first second stations to transmit a data packet having a shorter duration than the predetermined time interval over the wireless channel if the predetermined time interval is less than the time left before a scheduled start of a next frame by the plurality of second stations.

The foregoing and other features and advantages of the invention will be apparent from the following, more detailed description of preferred embodiments as illustrated in the accompanying drawings in which reference characters refer to the same parts throughout the various views.

### BRIEF DESCRIPTION OF THE DRAWINGS

FIG. 1 is a simplified block diagram illustrating the architecture of a wireless communication system whereto embodiments of the present invention are to be applied;

FIG. 2 illustrates a simplified block diagram of an access point (AP) and each station (STA) within a particular basic service set (BSS) according to an embodiment of the present invention;

FIG. 3 shows the structure of a superframe in accordance with the present invention;

FIG. 4 shows a detailed structure of the superframe representing a contention free period (CFP) in accordance with the present invention;

FIG. 5 shows a detailed structure of the superframe representing a contention period (CP) in accordance with the present invention;

FIG. 6 is a detailed structure of the superframe representing a contention period (CP) according to another embodiment of the present invention;

FIG. 7 is a detailed structure of the superframe representing a contention period (CP) according to a further embodiment of the present invention; and,

FIG. 8 is a flow chart illustrating the operation steps according to an embodiment of the present invention.

### DETAILED DESCRIPTION OF THE EMBODIMENTS

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

To help understand the invention, the following definitions are used:

A “Distributed Coordination function (DCF)” is a class of coordination functions where the same coordination function logic is active in every station in the BSS whenever the network is in operation.

A “Point coordination function (PCF)” is a class of possible coordination functions where the coordination function logic is active in only one station in a BSS at any given time that the network is in operation.

A “Contention Free Period (CFP)” is a time period during which frame exchanges occur without intra-BSS contention.

A “Contention Period (CP)” is a time period during the operation of a BSS when a DCF or HCF is active, and the right to transmit is determined locally using a carrier sense multiple access algorithm with collision avoidance (CSMA/CA).

A “Hybrid Coordination Function (HCF)” is a coordination function that combines aspects of the DCF and the PCF to provide the selective handling of the medium access control (MAC) service data units (MSDUs) required for the QoS facility, and allows stations to use a uniform set of frame exchange sequences during both the CFP and the CP.

An “Interworking” refers to a communication between HiperLAN/2 (H2) and EEEE 802.11a terminals in an integrated protocol where a centrally coordinating device is capable of operating in the 802.11 and H2 modes, i.e., by switching between two modes over time.

A “Transmission Opportunity (TXOP)” is an interval of time when a particular station has the right to initiate transmissions onto the wireless medium. A TXOP is defined by a starting time and a maximum duration.

A “Point Coordination Function (PCF) Interframe Space (PIFS)” is a priority level for accessing the wireless medium or a waiting time prior to any frame transmission.

A “H2 MAC frame” is a plurality of transmissions of H2 STAs and composed of (1) control broadcast by the AP; (2) data transmissions by the AP; and, (3) data transmission from the STAs. Each H2 MAC frame is 2 msec long and starts with a beacon transmission from the AP, where beacons are transmitted every 2 msec periodically. Each H2 STA can transmit data per its AP's permission during a specific time, which is determined by the AP and announced during control broadcast phase within a H2 MAC frame.

Now, a description will be made in detail with regard to this invention with reference to the drawings.

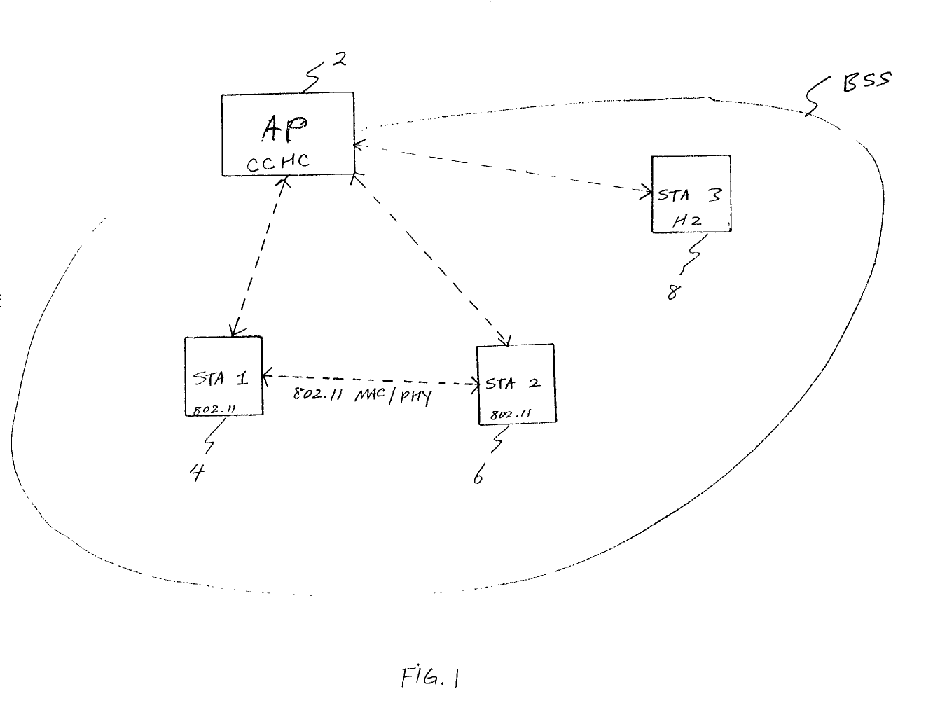

FIG. 1 illustrates a representative network whereto the embodiments of the present invention are to be applied. As shown in FIG. 1, an access point (AP) 2 is coupled to a plurality of mobile stations (STAᵢ), which, through a wireless link, are communicating with each other and to the AP 2 via a plurality of wireless channels. As shown in FIG. 1, the AP 2 has control over 802.11a/e 4 and 6, and H2 8 systems that are co-located within the same BSS in order to share the bandwidth in a time-shared manner. To this end, a hybrid H2 centralized controller (CC) and a 802.11a/e hybrid coordinator (HC) (hereafter referred to as “CCHC”), which has both the 802.11a/e MAC/PHY and the H2 MAC/PHY implemented therein, is provided in the AP 2 to render the time-sharing of the bandwidth between the 802.11a/e and the H2 devices. The CCHC communicates with all the 802.11a/e stations and the H2 mobile terminals located within the same BSS on a continuing basis to provide communication over the wireless channel. In addition, an 802.11e Hybrid Coordination Function (HCF), which allows a polling mechanism in both the CFP and the CP under the proposed 802.11e standard, may be implemented in the AP 2 to allocate periodically or exclusively the H/2 MAC frames into the CCHC superframe (explained later). Although a limited number of STAs is shown in FIG. 1 for illustrative purposes, it is to be understood that the AP 2 can support concurrent communications between a much larger number of STAs. Thus, the number of STAs in the drawing should not impose limitations on the scope of the invention.

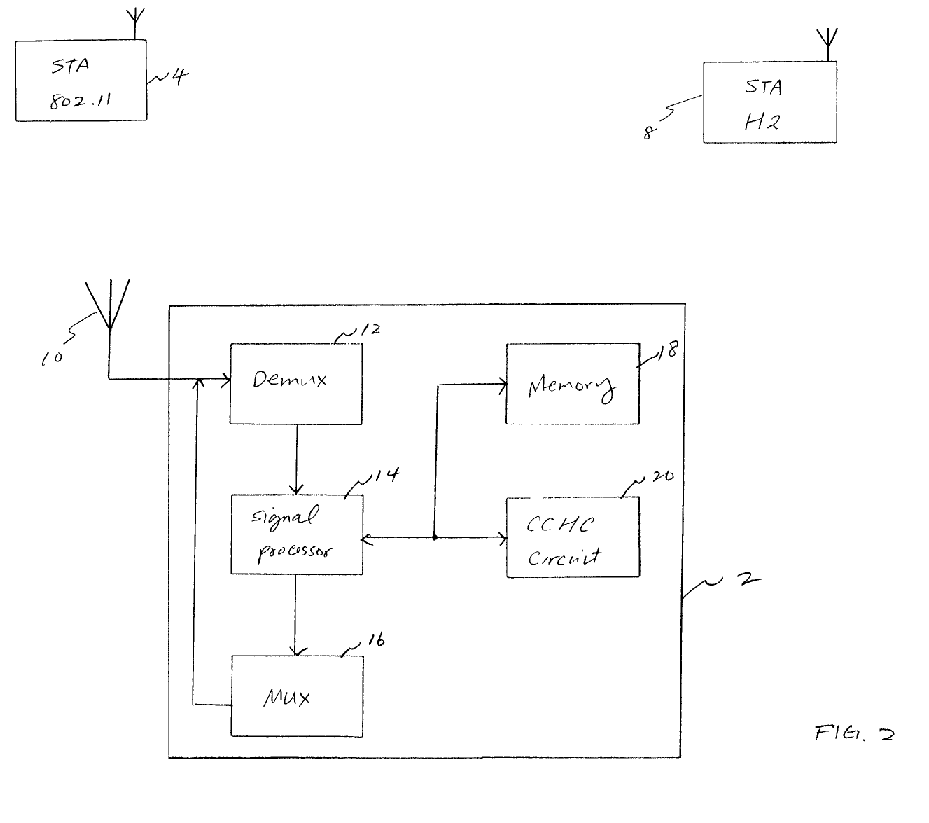

FIG. 2 shows a simplified block diagram of a WLAN according to a preferred embodiment of the present invention. The exemplary embodiment of FIG. 2 is for descriptive purposes only, thus other types of local area networks that employ a server station for forwarding messages back and forth to network stations may be employed. The AP 2 may be connected to other devices and/or networks within which network stations in the local area network may communicate. As shown in FIG. 2, each station includes an antenna 10 configured to transmit and receive data signals over a communications channel. The AP 2 includes a demodulator 12, a signal processor 14 for processing the signals received via an antenna 10, a modulator 16, a memory 18, and a CCHC circuit 20. The signal processor 14 also processes the signals that are intended for transmission by the AP 2 via antenna 10. The input port of the signal processor 14 is configured to receive a CCHC signal from an output port of the CCHC circuit 20. The CCHC circuit 20 is coupled to an input port of memory 18 that is configured to store the values of the CCHC parameters.

According to the embodiment of the present invention, the AP 2 further includes a Hybrid Coordination Function (HCF) in order to allocate periodically or exclusively HIPERLAN/2 MAC frames into a CCHC superframe using Contention-Free Scheduling (CF-Scheduling) or Polling (CF-Polling).

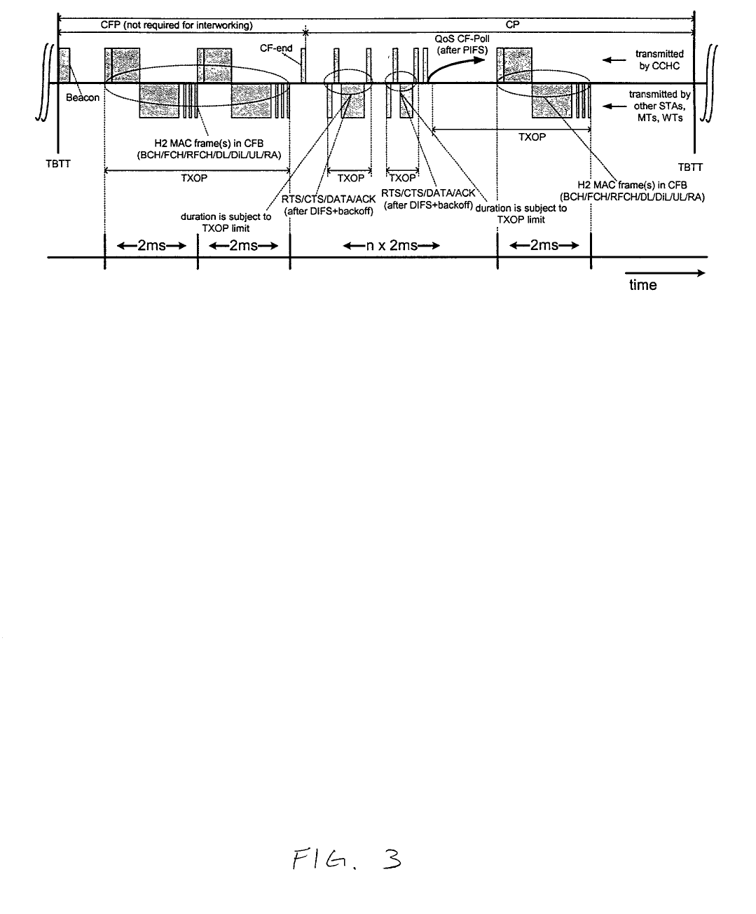

FIG. 3 illustrates the operation process of the Hybrid Coordination Function (HCf) in accordance with the present invention to allocate the H2 MAC frames into the CCHC superframe. As shown in FIG. 3, the AP 2 starts a CCHC superframe by transmitting a beacon frame to control the access to the wireless medium. This CCHC superframe, composed of a contention-free period (CFP) and a contention-period (CP), is repeated periodically by the AP 2 at a regular interval. During a CCHC superframe, there are multiple instances of “Transmission Opportunity (TXOP),” which represents the interval of time when a particular station, either the 802.11a/e or the H2, has the right to initiate transmissions onto the wireless medium. Hence, the TXOP is defined by a starting time and a maximum duration. Each H2 MAC frame of 2 msec duration is basically composed of (1) broadcast control transmission from the CCHC, (2) downlink (i.e., from CCHC to H2 STA) data transmission from the CCHC, and (3) uplink (i.e., from H2 STA to CCHC) data transmission from the H2 STAs. Each H2 MAC frame starts with the transmission of a H2 beacon, referred to as BCH in FIG. 3.

With continued reference to FIG. 3, the CP must be available after each CFP repetition interval with a specific minimum length in order to allow the exchange of at least one data frame. During the CFP, the control over the wireless channel is totally under the CCHC as the DCF operation of the STAs is in hold during this period. The TXOP is granted to a STA by the CCHC via a QoS CF-Poll frame, where the starting time and maximum duration of each TXOP is specified by HCF through the QoS CF-Poll frame header. After receiving the QoS CF-Poll signal, decisions regarding what to transmit are made locally by the MAC entity within the limits of each TXOP at the respective station. During the CP, the DCF operation is enabled, and each TXOP of a STA begins either when the medium is determined to be available by the STA under the DCF rules (referred to as DCF TXOP) or when the STA receives a QoS CF-Poll from the HCF (referred to as granted TXOP). The duration of a DCF TXOP is limited by a TXOP limit distributed in beacon frames, while the duration of a granted TXOP is specified in the QoS CF-Poll frame header as it is the case with the TXOP granted in the CFP. The key feature of rendering the sharing of the bandwidth lies in the ability of the HCF to selectively allocate TXOPs in both the CFP and the CP to allow the periodically scheduled H2 MAC frames into the CCHC superframe. That is, as the H2 standard defines the periodic transmission of beacons (i.e., Broadcast Channel or BCH according to H2 standard terms) every 2 msec, the H2 MAC frames have to be periodically allocated with a period of n*2 msec, where the value of n can vary over time depending on the schedule of the H2 MAC frame transmissions. When the H2 MAC frame is not allocated, which can happen if the value of n is larger than 1, the H2 STAs will not receive the BCH, and will assume that the channel error happened, and hence the normal H2 operation can not be affected. Therefore, the HCF (a function of AP 2 MAC) must provide an access scheme over the wireless channel to enable data transmission in both the CFP and the CP modes such that the window of TXOP coincides with the H2 MAC frame interval.

Now, the provision of an allocated time slot to support data transmission between the co-located 802.11a/e 4 and 6, and H2 8 systems according to the present invention will be explained in detailed description.

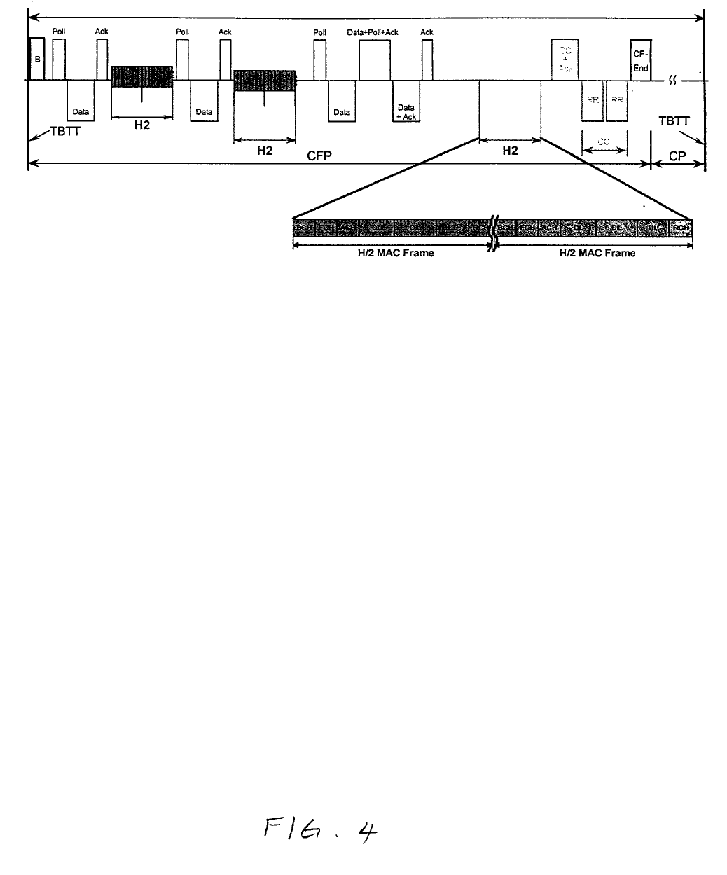

Referring to FIG. 4, during the CFP, the control over the wireless channel is totally under the CCHC as the DCF operation of the STAs is in hold during this period. That is, the CCHC can allocate H2 MAC frames according to its schedule whenever it wants. To comply with the H2 standard requirement of the periodic allocation of the frame at every 2 msec, the HCF initiates the H2 MAC frames by sending a BCH at n*2 msec interval according to its H2 MAC allocation schedule in the CCHC superframe. Alternatively, when the H2 MAC frame is not scheduled during CFP, the CCHC can perform the networking operation for the 802.11 STAs by transmitting downlink (i.e., from CCHC to 802.11 STA) frames as well as QoS CF-Poll frames.

In contrast, the control over the wireless channel is not fully under the CCHC during the CP. However, the CCHC can grab the control over the wireless channel by transmitting a downlink frame or a QoS CF-Poll frame after a PIFS long idle period of the channel. This gives a high priority to the CCHC over other STAs operating under DCF, which requires at least DIFS (longer than PIFS) idle period to transmit a frame.

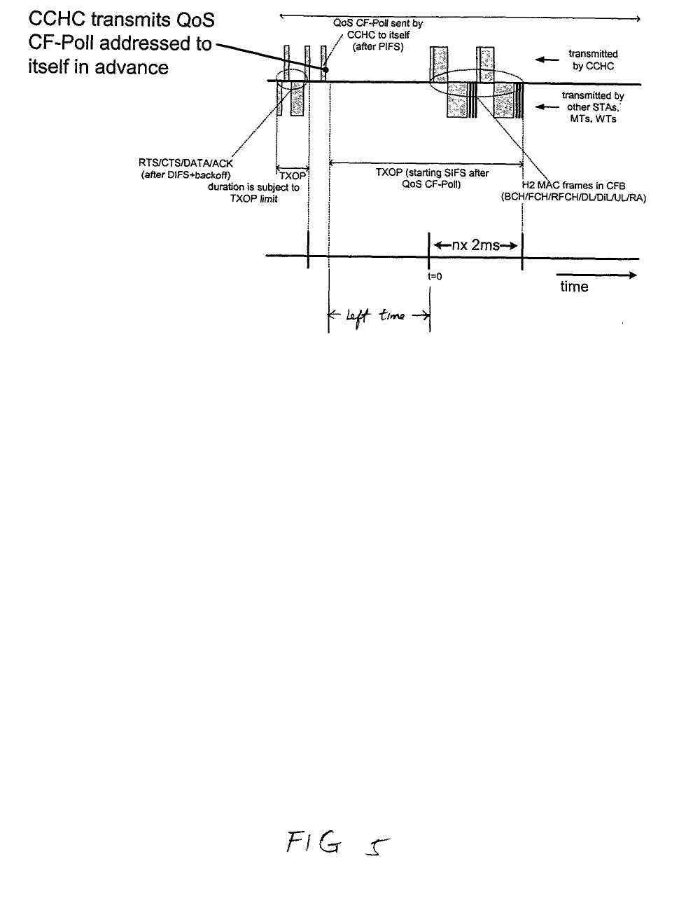

Referring to FIG. 5., during the CP, each TXOP begins either when the medium is determined to be available under the DCF rules (referred to as DCF TXOP), i.e., after the DIFS plus the back-off time, or when the station receives a QoS CF-Poll from the HCF as described above (referred to as granted TXOP). The duration of a DCF TXOP is limited by a “TXOP limit” determined by the CCHC and announced via beacon frames periodically, while the duration of a granted TXOP is specified in the QoS CF-Poll frame header. During the granted TXOP, all the STAs other than the polled STA disable the DCF operation so that the duration of the granted TXOP can be contention-free. As the H2 MAC frames must to be allocated at n*2 msec interval, the HCF must access the channel during the CP within a specified range of time (which is indicated as the “left time” in FIG. 5 for simplicity), so that the allocation of the H2 MAC frame can occur at n* 2 msec interval, where the value of n is determined by the schedule of the CCHC. To achieve this, the CCHC uses its high priority and transmits the QoS CF-Poll frame addressed to itself in advance to suppress all the stations within the BSS silent during the period it wants to transmit the H2 MAC frames. Stated otherwise, if the next H2 MAC frame that needs to be allocated must occur at time t=0, then the QoS CF-Poll sent by the CCHC to itself for the H2 MAC frame transmission following a PIFS must occur prior to t=0. As such, after the last TXOP, the CCHC waits for the duration of the PIFS and then transmits the QoS CF-Poll signal to other stations to allow the transmission of the next H2 MAC frame after t=0. It should be noted that there should be at least the Short Interframe Space (SIFS) time gap between the QoS CF-Poll frame and the BCH of the following H2 MAC frame.

In order to ensure the initiation of the H2 MAC frames as scheduled, the CCHC needs to access the channel before the H2 MAC frame scheduled time. Thus, if the CCHC likes to initiate an H2 MAC frame at t=0, the CCHC should access the channel within the time frame of [−1*(TXOP_Limit+QoS CF-Poll frame duration+SIFS), −1*(QoS CF-Poll frame duration+SIFS)]. If the channel is idle at t=1*(TXOP₁₃ Limit+QoS CF-Pollframe duration+SIFS), then the CCHC should grab the channel at that moment. Otherwise the CCHC will need to access the channel as soon as the wireless medium becomes idle.

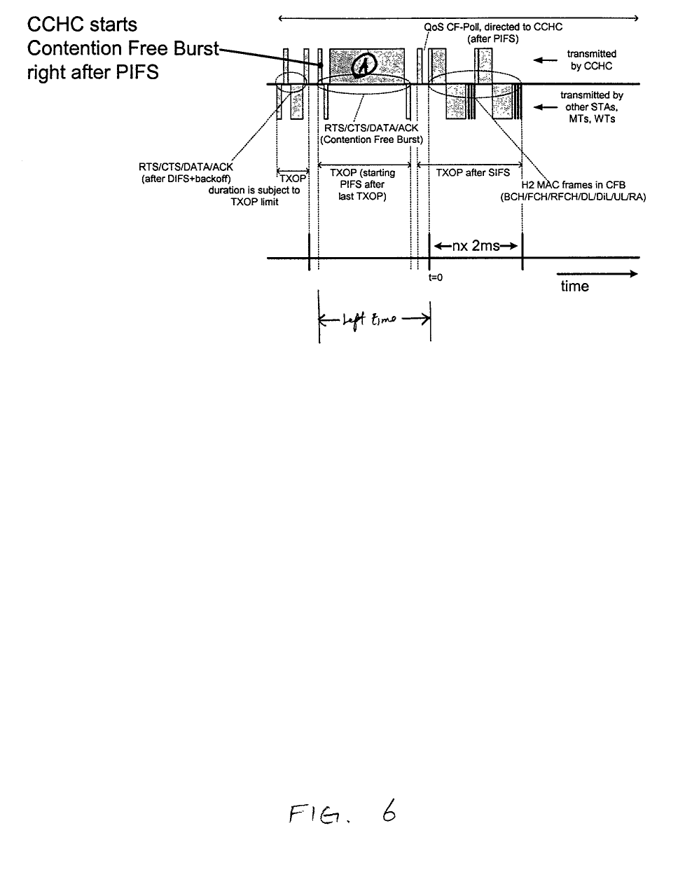

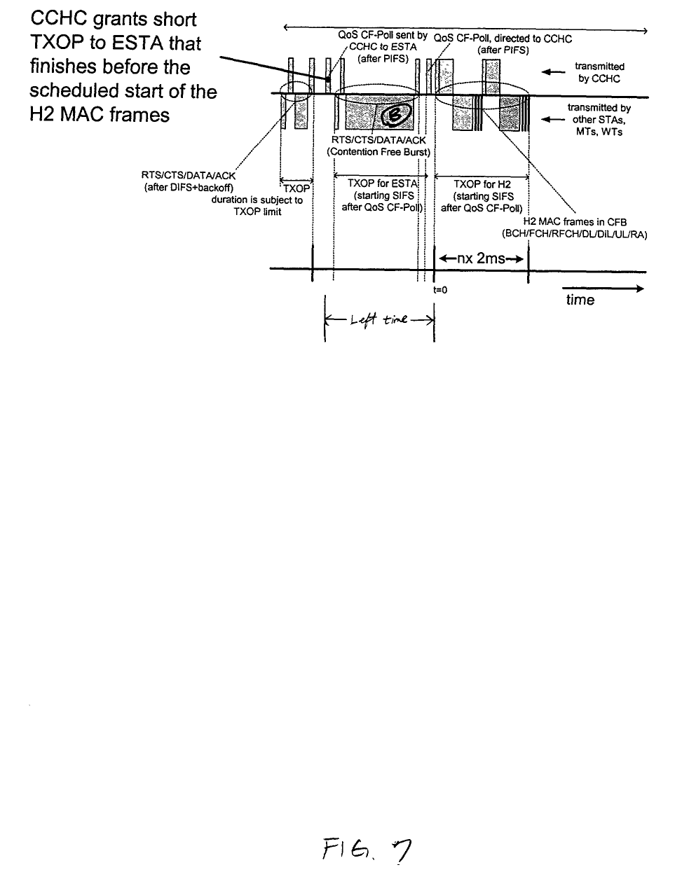

In the embodiment of the present invention, accessing the channel to enable a subsequent allocation of the H2 MAC frame as described above is desirable if the TXOP limit specified by the HCF is longer than the duration of the “left time” before a scheduled start of the next H2 MAC frame. Thus, the “left time” represents an interval of time following receipt of the last frame from the stations and before a scheduled start of the next H2 frame. However, if the “left time” is longer than the TXOP limit, a waste of bandwidth occurs as the CCHC must wait longer to transmit the QoS CF-Poll during which the bandwidth is not used. To address this problem, the present invention further provides a mechanism to efficiently utilize the bandwidth as described hereinbelow with reference to FIGS. 6 and 7.

Referring to FIG. 6, if the “left time” is longer than the TXOP limit, the AP 2 can transmit some downlink (i.e., from CCHC to 802.11 STA) frames to other stations. That is, if the HCF has a frame (labeled as “A” in FIG. 6) with a duration that does not exceed the left time or the time left till the next scheduled H2 MAC frame, the AP 2 can send that frame “A” before the scheduled H2 frame transmission. Thereafter, the CCHC waits for the duration of the PIFS and then transmits the QoS CF-Poll to allocate the scheduled H2 MAC frame.

Alternatively, the AP 2 can grant a shorter TXOP to other stations, such that a frame (labeled as “B” in FIG. 7) can be transmitted by other stations to the AP 2 before the scheduled start of the next H2 MAC frames, as shown in FIG. 7. The duration of the frame “B” should not exceed the left time. Thereafter, the CCHC waits for the duration of the PIFS and then transmits the QoS CF-Poll to start the next H2 MAC frame.

Accordingly, if there is enough time and relevant frames to transmit either frame as described above, the CCHC can do so while securing the transmission of a QoS CF-Poll addressed to itself at t<=−1*(QoS CF-Poll frame duration+SIFS). If doing either of them is not relevant due to the situation—i.e., there is not enough time or the CCHC does not have any downlink frames nor any QoS CF-Poll scheduled—the CCHC can send a QoS CF-Poll addressed to itself immediately, and wait for the start of the next scheduled H2 MAC frame(s). In such an event, the maximum length of the interval between the QoS CF-Poll and the next scheduled H2 MAC frame is TXOP limit+SIFS. The duration of the TXOP granted by the QoS CF-Poll should be at least the sum of (1) the remaining time until the start of the next scheduled H2 MAC frame(s) and (2) n*2 msec, where n is the number of the scheduled H2 MAC frames.

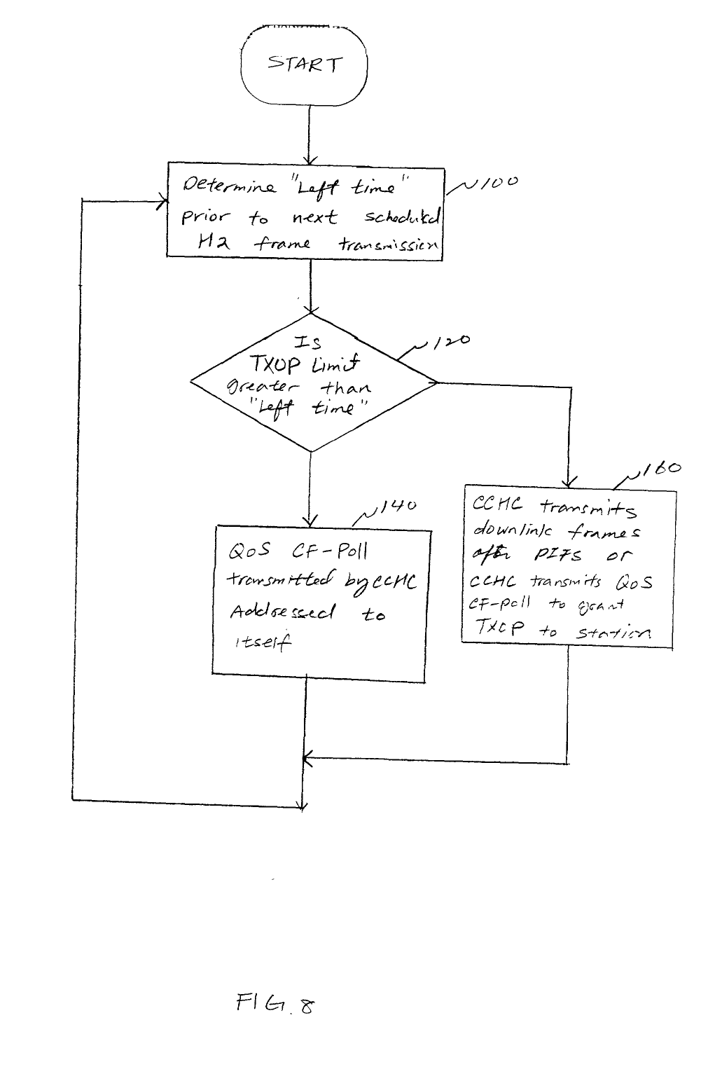

FIG. 8 is a flow chart illustrating the operation of a software embodiment of the AP 2 that describes the operation steps discussed in conjunction with FIGS. 5 through 7 in accordance with the techniques of the present invention. This flow chart is generally applicable to a hardware embodiment as well. The flow chart does not depict the syntax of any particular programming language. Rather, the flow diagrams illustrate the functional information that a person of ordinary skill in the art needs to fabricate circuits or to generate a computer software to perform the processing required of the particular apparatus.

In step 100, prior to accessing the channel to initiate the H2 MAC frames as scheduled, the CCHC of the AP 2 determines the “left time” indicating the duration till the next scheduled H2 frame transmission. If the duration of the “left time” is shorter than the TXOP limit that is specified in the CCHC superframe in step 120, or more accurately if the left time is within the time frame of [([(QoS CF-Poll frame duration+SIFS), (TXOP_Limit+QoS CF-Poll frame duration+SIFS)], the CCHC waits for the duration of the PIFS channel idle time and then transmits the QoS CF-Poll frame to itself in step 140, to allow the transmission of the H2 MAC frames. If the duration of the “left time” is longer than the TXOP limit in step 120, or more accurately if the left time is over (TXOP_Limit+QoS CF-Poll frame duration+SIFS), and the CCHC has some downlink frames, which can finish before the scheduled start of the next H2 MAC frame, the CCHC transmits the downlink frames to other 802.11 stations in step 160. Alternatively, the CCHC may grant a short TXOP to other 802.11 stations to send a frame before the scheduled start of the next H2 MAC frames.

As is apparent from the foregoing, the present invention has an advantage in that a hybrid of the 802.11e H2 controller (CCHC), which has both the 802.11a/e and the H2 MAC/PHY implementation, allows resource sharing between the 802.11a/e and the H2 without compromise of the QoS supported by each system. In an alternative embodiment, two APs for each of the 802.11e and the H/2 networks may be provided to control the 802.11e and H2 systems, respectively. In this instance, the two APs may communicate with each other to share the resources based on the preset policy between the 802.11 and H2 networks. The H2 CC will need to understand the 802.11a PHY, as well as the 802.11e beacon, and CF-poll functions. Similarly, the 802.11 HC will need to adjust the CF-Poll for the H2 to meet the QoS requirement of the H2 systems. Then, a negotiation/communication between two control entities may be performed to implement in accordance with the techniques of the present invention.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A method for sharing the bandwidth over a wireless channel between a plurality of first stations and a plurality of second stations in a wireless local area network (WLAN) having an access point (AP), the method comprising the steps of:
periodically transmitting, by said AP, a control frame comprising data indicative of a predetermined time interval during which each of said first stations can occupy the wireless channel for the data transmissions onto said wireless channel;
determining, by said AP, whether said predetermined time interval specified in said control frame is longer than an interval of time following receipt of a last frame from one of said first stations and before a scheduled start of a set of next frames from at least one of said second stations;
if so, waiting, by said AP, for point interframe spacing interval (PIFS) after which said next frames from said second stations are permitted to transmit to said AP over said wireless channel; and,
inhibiting transmission from said plurality of first stations to said AP.

2. The method of claim 1, further comprising the step of permitting said plurality of second stations to transmit a data packet to said AP over said wireless channel, said data packet including a shorter duration than said predetermined time period specified in said control signal.

3. The method of claim 1, wherein, if said predetermined time interval specified in said control frame is less than said interval of time before the scheduled start of said next frame, transmitting, by said AP, a data packet to said plurality of first and second stations over said wireless channel, said data packet including a shorter duration than said predetermined time period specified in said control signal.

4. The method of claim 1, wherein, if said predetermined time interval specified in said control frame is less than said interval of time before the scheduled start of said next frame, permitting said plurality of first stations to transmit a data packet to said AP over said wireless channel, said data packet including a shorter duration than said predetermined time period specified in said control signal.

5. The method of claim 1, further comprising the steps of:
determining whether said wireless channel between said AP and said plurality of first and second stations is available;
if so, inhibiting transmission from the plurality of said first stations to said AP;
transmitting, from said AP to said plurality of first stations, a high priority signal indicative of a duration that said plurality of second stations is allowed to occupy said wireless channel; and,
permitting said plurality of second stations to transmit a data packet to said AP over said wireless channel, said data packet including a shorter duration than said predetermined time period specified in said control signal.

6. The method of claim 1, wherein said plurality of first stations includes 802.11 compliant systems.

7. The method of claim 1, wherein said plurality of second stations includes HIPERLAN/2 compliant systems.

8. The method of claim 1, wherein said plurality of first stations can transmit data frames without permission from said AP and said plurality of second stations can transmit data frames when permitted by said AP.

9. A method for sharing the bandwidth over a wireless channel between a plurality of first stations and a plurality of second stations in a wireless local area network (WLAN) having an access point (AP), the method comprising the steps of:
transmitting a control frame having a contention free period (CFP) mode and a contention period (CP) mode, said control frame including data indicative of a predetermined time interval that each of said first stations has to complete data transmission onto said wireless channel;
determining whether said wireless channel between said AP and said plurality of first and second stations is available;
if said wireless channel is available during said CP mode, polling at said AP to inhibit transmission of said plurality of first stations over said wireless channel; and,
permitting said plurality of second stations to transmit a data packet to said AP over said wireless channel, said data packet including a shorter duration than said predetermined time period specified in said control signal.

10. The method of claim 9, wherein the step of permitting said plurality of second stations to transmit a data packet to said AP over said wireless channel further comprises the steps of:
determining, by said AP, whether said predetermined time interval specified in said control frame is longer than an interval of time following receipt of a last frame from one of said first stations and before a scheduled start of a set of next frames from at least one of said second stations;
if so, determining a range of time [t₁, t₂] to control said wireless channel by said AP; and,
controlling said wireless channel within said time range to permit said plurality of second stations to transmit a data packet.

11. The method of claim 10, wherein said range of time is determined according to the following equation.
[t₁, t₂]=[−1* (TXOP_Limit+QoS CF-Poll frame duration+SIFS), −1* QoS CF-Poll frame duration+SIFS),
wherein TXOP_Limit represents said predetermined time period that said plurality of first stations can transmit data frames after said wireless channel is determined to be available, QoS CF-Poll frame duration represents the duration of a QoS CF-Poll frame used to instruct said AP to inhibit transmission from said plurality of first stations, and SIFS represents the duration of a Short Interframe Space interval.

12. The method of claim 10, wherein, if said wireless channel is unavailable, permitting said plurality of second stations to transmit a data packet to said AP over said wireless channel immediately when said wireless channel becomes available.

13. The method of claim 10, wherein, if said predetermined time interval specified in said control frame is less than said interval of time before the scheduled start of said next frame, transmitting, by said AP, a data packet to said plurality of first and second stations over said wireless channel, said data packet including a shorter duration than said predetermined time period specified in said control signal.

14. The method of claim 10, wherein, if said predetermined time interval specified in said control frame is less than said interval of time before the scheduled start of said next frame, permitting said plurality of first stations to transmit a data packet to said AP over said wireless channel, said data packet including a shorter duration than said predetermined time period specified in said control signal.

15. The method of claim 9, wherein, if said wireless channel is available during said CFP mode, the method further comprises the steps of:
transmitting, from said AP to said plurality of first and second stations, a high priority signal indicative of a duration that said plurality of first and second stations is allowed to occupy said wireless channel; and,
permitting said plurality of second stations to transmit a data packet to said AP over said wireless channel, said data packet including a shorter duration than said predetermined time period specified in said control signal.

16. The method of claim 9, wherein said plurality of first stations includes 802.11 compliant systems.

17. The method of claim 9, wherein said plurality of first stations can transmit data frames without permission from said AP and said plurality of second stations can transmit data frames when permitted by said AP.

18. The method of claim 10, wherein said plurality of second stations includes HIPERLAN/2 compliant systems.

19. A system local area network station for receiving and transmitting data over a wireless channel between a plurality of first stations and a plurality of second stations in a wireless local area network (WLAN) having an access point (AP), comprising:
a receiver means for receiving data on said wireless channel;
a CCHC circuit configured to allocate a predetermined time interval for each of said first and second stations to initiate data transmission onto said wireless channel; and,
a signal processing circuit coupled to said CCHC to transmit and receive signals to and from said plurality of first and second stations, said signal processing circuit processes signals received therein to permit said plurality of second stations to transmit a data packet to said AP over said wireless channel, said data packet including a shorter duration than said predetermined time period specified in said control signal.

20. The system of claim 19, further comprising a transmitter means for transmitting data on said wireless channel.

21. The system of claim 19, wherein said CCHC further operates to inhibit transmission from said plurality of first and said second stations when permitting said plurality of second stations to transmit a data packet.

22. The system of claim 19, wherein said CCHC further operates to control said wireless channel within a specified range of time [t₁, t₂] to permit said plurality of second stations to transmit a data packet.

23. The system of claim 22, wherein said time range [t₁, t₂] is determined according to the following equation:
t₁, t₂]=[−1* (TXOP_Limit+QoS CF-Poll frame duration+SIFS), −1* QoS CF-Poll frame duration+SIFS),
wherein TXOP_Limit represents said predetermined time period that said plurality of first stations can transmit data frames after said wireless channel is determined to be available, QoS CF-Poll frame duration represents the duration of a QoS CF-Poll frame used to instruct said AP to inhibit transmission from said plurality of first stations, and SIFS represents the duration of a Short Interframe Space interval.

24. The system of claim 19, wherein said CCHC further operates to transmit a data packet to said plurality of first and second stations over said wireless channel if said predetermined time interval is less than the time left before a scheduled start of a next frame by said plurality of second stations.

25. The system of claim 19, wherein said CCHC further operates to permit transmission of said plurality of first second stations to transmit a data packet having a shorter duration than said predetermined time interval over said wireless channel if said predetermined time interval is less than the time left before a scheduled start of a next frame by said plurality of second stations.

26. The system of claim 19, wherein said plurality of first stations includes 802.11 compliant systems.

27. The method of claim 19, wherein said plurality of second stations includes HIPERLAN/2 compliant systems.
